(19) United States
(12) Patent Application Publication
(10) Pub. No.: US 2017/0206658 A1
(43) Pub. Date: Jul. 20, 2017

(54) IMAGE DETECTION OF MAPPED FEATURES AND IDENTIFICATION OF UNIQUELY IDENTIFIABLE OBJECTS FOR POSITION ESTIMATION

(71) Applicant: ABL IP HOLDING LLC, Conyers, GA (US)

(72) Inventors: Daniel M. Megginson, Fairfax, VA (US); Sean P. White, Reston, VA (US); David P. Ramer, Reston, VA (US); Jack C. Rains, JR., Herndon, VA (US)

(21) Appl. No.: 14/996,975

(22) Filed: Jan. 15, 2016

(51) Int. Cl. G06T 7/00; G06K 9/00; G06K 9/46

(52) U.S. Cl. CPC G06T 7/0044; G06K 9/4604; G06K 9/00577

(57) ABSTRACT

A collection of defining features of an object uniquely identify the object. The defining features individually and the collection as a whole are humanly imperceptible. Various uniquely identifiable objects are mapped within a space based on corresponding collections of defining objects and known locations. Location information for the uniquely identifiable object is obtained by a mobile device after identifying the object based on the collection of defining features. Location of the mobile device is estimated based on obtained location information of one or more uniquely identifiable objects.

### TECHNICAL FIELD

The present subject matter relates to techniques and equipment to identify defining features of objects within a space as well as map a plurality of identifiable objects within the space, for example, for use in estimation of position.

### BACKGROUND

In recent years, the use of mobile devices, particularly smartphones and tablets, has grown significantly. An increasing use for a mobile device includes identifying a current location of the mobile device and utilizing information about the identified location to assist a user of the mobile device. For example, the mobile device may display a map of an area in which the mobile device user is currently located as well as an indication of the user's location on the map. In this way, the user may utilize the mobile device as a navigational tool, for example.

Traditionally, a mobile device may use location identification services such as Global Positioning System (GPS) or cellular communications to help identify a current location of the mobile device. However, GPS and cellular communications may not provide sufficient information when the mobile device is located within a building. More recently, the mobile device may use Wi-Fi and/or other radio frequency (RF) technologies (e.g., Bluetooth, Near-Field Communications (NFC), etc.) to help identify the current location of the mobile device within a building. But such Wi-Fi and RF based solutions may be slow and may require that additional infrastructure, such as hotspots or beacons, be added within the building. This additional infrastructure has additional costs that may not be outweighed by any benefit provided to the user of the mobile device.

Hence a need exists for providing improved location estimation services within a building with minimal delay and without requiring additional infrastructure.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a simplified block diagram of an example of a ceiling including a plurality of uniquely identifiable objects.

FIG. 2 is a simplified block diagram of an example of a wall including a plurality of uniquely identifiable objects.

FIG. 3 is a simplified block diagram of an example of a ceiling and a wall including uniquely identifiable objects as well as elements of an example of a system that may utilize the uniquely identifiable objects to facilitate estimation of a current location of a mobile device.

FIG. 4 is a simplified flow chart of an example of a process in which uniquely identifiable objects are identified and relevant feature information is recorded.

FIG. 5 is a simplified flow chart of an example of a process in which an object is analyzed to determine whether the object is uniquely identifiable.

FIG. 6 is a simplified flow chart of an example of a process in which features of an object are analyzed to determine whether the features uniquely identify the object.

FIG. 7 is a simplified flow chart of an example of a process in which a uniquely identifiable object is associated with other uniquely identifiable objects within a space or a portion of a space.

FIG. 8 is a simplified flow chart of an example of a process in which processing of an image of a uniquely identifiable object enables location estimation of a mobile device.

FIG. 9 is a simplified flow chart of an example of a process in which features of an object are analyzed and compared to identify the object.

FIG. 10 is a simplified functional block diagram of a mobile device, by way of an example of a portable handheld device.

FIG. 11 is a simplified functional block diagram of a personal computer or other work station or terminal device.

FIG. 12 is a simplified functional block diagram of a computer that may be configured as a host or server, for example, to function as the server in the system of FIG. 3.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

As discussed briefly in the background, Wi-Fi and RF based approaches have been developed in order to facilitate estimation of a current location of a mobile device. However, these approaches have significant costs that may outweigh any potential benefits. An additional approach to facilitate estimation of a current location of a mobile device has been developed that involves active interaction between a light fixture and the mobile device. More specifically, light produced by a light source within the light fixture is modulated with information such that the information is delivered to the mobile device. Such information, for example, includes an identifier of the light fixture or other data that corresponds to or otherwise represents a location of the light fixture. Based on the location of the light fixture, the mobile device may estimate or obtain an estimate from a server of a current location for the mobile device. Such visible light communication (VLC) based solution, however, requires that the light fixture be on or otherwise capable of producing and modulating light. Upgrade of numerous light fixtures to all modulate light outputs also incurs infrastructure costs. In addition, VLC requires that the mobile device is able to identify and interpret any information delivered as part of the modulated light. If the light source within the light fixture is unable to produce light (e.g., light source is powered off or has failed), the particular source is unable to modulate light, or the mobile device is unable to identify or interpret the modulated light, VLC is useless in facilitating a current location estimate of the mobile device. To overcome the shortcomings of the active approach to identifying a light fixture via VLC, an alternative passive approach to identifying an object within a space has been developed, as shown in the drawings and described in detail below.

The various examples disclosed herein relate to uniquely identifying objects using a passive approach in order to facilitate location estimation of a mobile device. The various examples disclosed herein also relate to a process of associating a uniquely identifiable object with other uniquely identifiable objects within a space or portion of a space as well as a process of utilizing the uniquely identifiable object and associated uniquely identifiable objects to facilitate estimating a current location of a mobile device. The term “object” is meant to refer to any one item within a space that is visible or tangible and is relatively stable in form. Thus, a door, a window, a thermostat, an air vent and a ceiling tile are all objects within a room.

In one example, an object within a space or a portion of the space has multiple features, detectable at least by an image sensor, that define the object as uniquely identifiable. These defining features include, for example, naturally or organically occurring features of the object as well as specific features intentionally or accidentally imposed on the object. For example, due to manufacturing imperfections, the size of an outer rim may vary between a number of light fixtures or one side of a window frame may be wider or more narrow than another side of the window frame. As another example, during installation, an installer may slightly damage one or more objects (e.g., dent or otherwise bend a light switch cover plate, scrape or otherwise damage a door, install one or more misaligned ceiling tile spacers). As still another example, a gradient or lens installed to cover a light source within a light fixture may contain a small hole or other imperfection that impacts light emitted from the light fixture or an air vent may contain a stain. Thus, defining features may be physical features, passive optical features or emissive characteristics of the object.

The defining features that enable an object to be uniquely identifiable collectively form a “fingerprint” of the object, in the detailed examples described below. That is, the object fingerprint is a collection of features of the object and such collection of features sufficiently distinguish the object from other objects installed within a space or a portion of the space. The identifying function of such object fingerprint is, for example, humanly imperceptible. Also, the defining features that form the object fingerprint typically do not negatively impact performance of the object or otherwise unnecessarily impede the object from performing an intended or expected function. Humanly imperceptible with reference to the fingerprint is intended to mean that, while a user may (or may not) view or otherwise see the individual defining features, the user will not perceive the collection of defining features (i.e., the object fingerprint) as performing an identification function. That is, unlike a bar code or quick response (QR) code which is easily perceived as identifying an item, the object fingerprint in various examples below is not readily perceivable as identifying an object. The collection of defining features that form the object fingerprint, however, is detectable as an identification of the object by processing of an image of the fingerprinted object.

While the defining features may take any of a number of forms for any one object, the defining features will change for each object within a set of objects such that each changed fingerprint uniquely identifies one object from within the set of objects (unique at least within some area of interest, e.g. a room, a building or a campus). For example, given a collection of defining features forming a fingerprint, that collection of defining features will change from one object to the next object within the set of objects, e.g., at a particular facility such that each object at the facility is uniquely identified from within the set of objects. As a further example, given a set of three objects and a collection of defining features, a first object A may include a first collection of defining features (e.g., bent frame and a wider outer frame of a window); a second object B may include a second collection of defining features (e.g., different gradient curvature and different angle of installation of a light fixture); and a third object C may include a third collection of defining features (e.g., surface imperfection and misaligned installation of an air vent). In this way, each of object A, object B and object C may be uniquely identified from within the set of three objects. Furthermore, the three objects A, B, C and their locations in a room may then identify the room.

It should be noted that objects are common within an indoor space, such as a retail area within a retail location or offices within an office building. It should also be noted that location information for each object within the indoor space may be made readily available as a result of an initial mapping process and/or updated subsequently over time. As such, given known locations for uniquely identifiable objects, a process may be performed to estimate, at least in relation to two or more uniquely identifiable objects, a current location for a mobile device observing the objects. A modern mobile device typically includes one or more image sensors, e.g. cameras, which may be used in position estimation and/or related operations. For example, a mobile device may capture an image including at least two uniquely identifiable objects. As part of image processing in this example, each of the at least two uniquely identifiable objects is isolated within the image. Once isolated, each isolated portion of the image representing one of the at least two uniquely identifiable objects is analyzed to determine, for example, whether the represented object includes defining features. Once defining features are determined for each represented object, each represented object may be identified based on the defining features found in the isolated portion of the image representing the respective object; and a location of the respective object may be determined based on the identification of the respective object. In this example, a location of the mobile device may then be estimated based on locations of at least two of the uniquely identifiable objects.

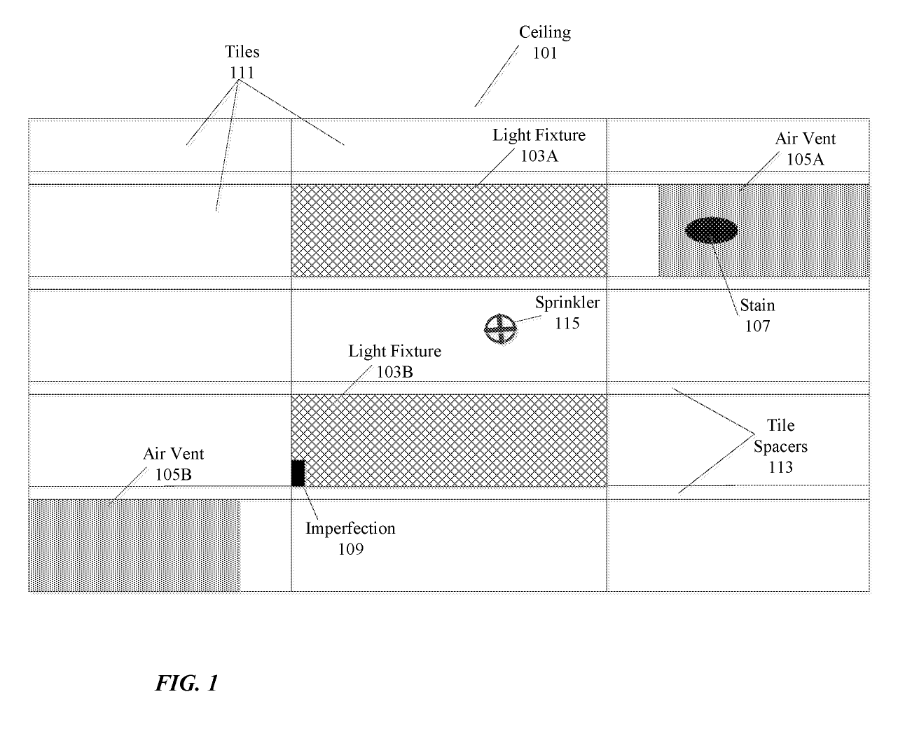

Reference now is made in detail to the examples illustrated in the accompanying drawings and discussed below. FIG. 1 illustrates an example of a ceiling 101 which may be installed within a space including a plurality of objects that may be uniquely identifiable. For example, ceiling 101 includes a number of tiles 111 as well as tile spacers 113. Ceiling 101 also includes, for example, light fixtures 103A, 103B. In addition, ceiling 101 includes air vents 105A, 105B as well as sprinkler 115. In the example of FIG. 1, any number of the included objects may be uniquely identifiable, at least in relation to the ceiling 101 and the room containing ceiling 101. For example, air vent 105A includes stain 107 and light fixture 103B includes imperfection 109. That is, stain 107 is a defining feature of air vent 105A and imperfection 109 is a defining feature of light fixture 103B. As such, stain 107 enables air vent 105A to be distinguished from air vent 105B and each of air vents 105A, 105B are uniquely identifiable, at least in relation to ceiling 101. Similarly, imperfection 109 enables light fixture 103B to be distinguished from light fixture 103A and each of light fixtures 103A, 103B are uniquely identifiable, at least in relation to ceiling 101. In addition, because sprinkler 115, for example, is the only sprinkler within ceiling 101, sprinkler 115 is also uniquely identifiable, at least in relation to ceiling 101.

While any number of the various objects within ceiling 101 may each be uniquely identifiable based on a respective object fingerprint (e.g., sprinkler 115 being sole sprinkler; air vent 105A being an air vent and including stain 107; light fixture 103B being a light fixture and including imperfection 109), the various objects are also defining features of ceiling 101 and form an object fingerprint for ceiling 101. In other words, a first uniquely identifiable object may be a defining feature of a second uniquely identifiable object that includes or otherwise contains the first uniquely identifiable object. In turn, the second uniquely identifiable object may form a portion of the space in which the various objects exist (e.g., ceiling 101 within the room containing ceiling 101). That is, a unique sub-area may be defined or otherwise represented by one uniquely identifiable object for which an object fingerprint is formed by a collection of defining features including one or more other uniquely identifiable objects (i.e., ceiling 101 is a unique sub-area within the room containing ceiling 101).

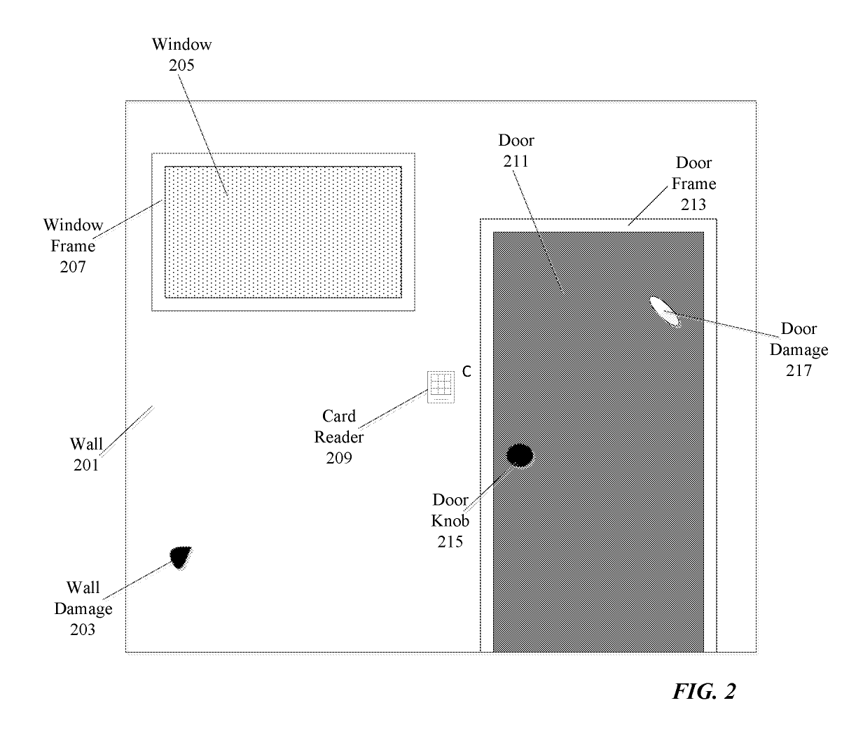

FIG. 2 illustrates an example of a wall 201 which may be installed within a space including a plurality of objects that may be uniquely identifiable. Wall 201 includes, for example, door 211, card reader 209 and window 205. As in the example of FIG. 1, any number of the included objects may be uniquely identifiable, at least in relation to the wall 201 and the room containing wall 201. For example, door 211 includes door knob 215, door frame 213 and door damage 217. Similarly, window 205 includes, for example, window frame 207. Furthermore, wall 201 includes, for example, wall damage 203. That is, in addition to including uniquely identifiable objects such as window 205 and door 211, wall 201 is also uniquely identifiable as an object, at least in relation to the room containing wall 201. For example, wall 201 may be uniquely identifiable as compared to other walls within the same room. As with ceiling 101 in FIG. 1, wall 201 is also a unique sub-area within the room containing wall 201.

Although the examples of FIGS. 1-2 depict various examples of specific objects, this is only for simplicity. Within any given space, any portion of that space (e.g., a wall, a ceiling, a portion of a wall) may include any number of objects. Furthermore, even if multiple objects of the same type (e.g., light fixtures, air vents, windows) exist within the same portion of that space, each of the multiple objects may be of a different shape and/or size. In fact, differences between objects of the same type are part of a first collection of defining features that form an object fingerprint for a first object and part of a second collection of defining features that form an object fingerprint for a second object. Thus, a first collection of defining features may define a first object fingerprint of a first object (e.g., air vent 105A including stain 107) while a second collection of defining features may define a second object fingerprint of a second object (e.g., air vent 105B without any additional defining features). Furthermore, the first collection of defining features and the second collection of defining features may both include the same defining features, but with different values or characteristics for each included defining feature (e.g., light fixture 103B with imperfection 109 and light fixture 103A with no imperfections). Alternatively, or in addition, the first collection of defining features and the second collection of defining features may each include different defining features. For example, given the addition of a small transom window above door 211 of FIG. 2, an object fingerprint of the transom window may be based on window size and window location in relation to door 211 while an object fingerprint for window 205 may be based on window size and existence of window frame 207.

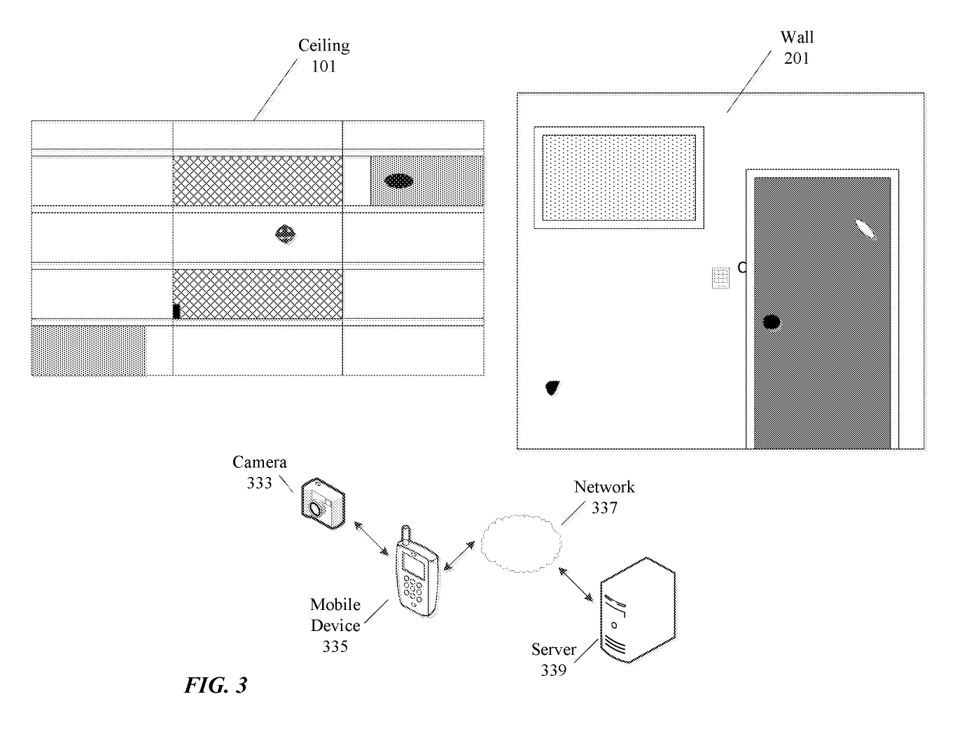

FIG. 3 depicts an example of a system that may utilize defining features of objects within ceiling 101 and/or wall 201 to facilitate location estimation of a mobile device, such as mobile device 335. As in previous FIGS. 1-2, ceiling 101 and wall 201 include various objects. Some number of the included objects are uniquely identifiable based on object fingerprints formed by various defining features of respective objects, as discussed above in relation to FIGS. 1-2. Once again, as discussed above, while FIG. 3 depicts objects with defining features that are visible to the reader of this disclosure, this is only for simplicity in explanation and teaching. In practice, while an individual object may be uniquely identified based on a collection of defining features forming a fingerprint of the object, such object fingerprint will be relatively imperceptible to most human observers as uniquely identifying the object. Of note, it should be understood that, given a set of objects, changes to defining features depicted on various objects within the set allow each object to be uniquely identified, at least in relation to other objects within the set.

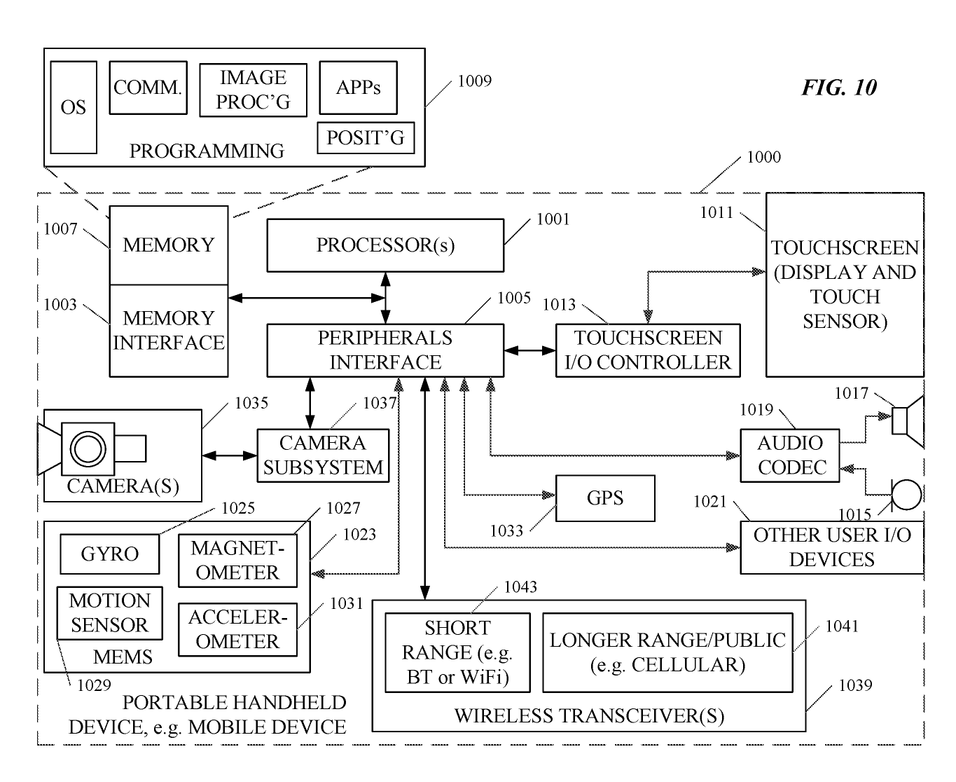

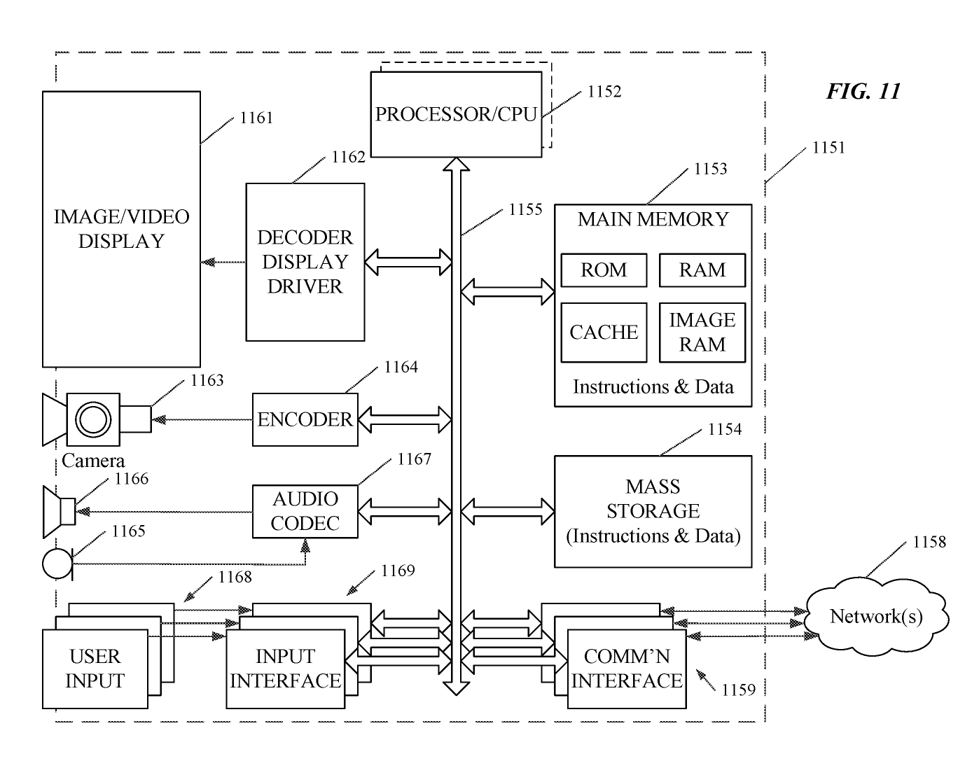

In the system of FIG. 3, camera 333, for example, will take a picture of a space including ceiling 101 and/or wall 201. Such captured image will be processed by software and/or hardware processing elements of the mobile device 335. Although camera 333 and mobile device 335 are depicted as separate elements, this is only for simplicity and it is well known that various mobile devices include or otherwise incorporate a camera or image sensor. Thus, in an alternate example (e.g., FIGS. 10 and 11), a mobile device may utilize an included or otherwise incorporated camera or other image sensor to capture a picture including at least a portion of ceiling 101 and/or at least a portion of wall 201.

Mobile device 335, in one example, processes a captured image including a part of ceiling 101 and/or a part of wall 201. Such processing includes, for example, isolating each of the objects within the captured image, analyzing each isolated portion of the image containing an object to determine if defining features are included in the object and analyzing defining features detected in some number of the objects contained in the image to determine identifications of the various objects. Although some or all of such processing may be performed directly by mobile device 335, alternatively some or all of such processing may be performed by server 339 by transferring the captured image or an isolated portion of the image representing an object to server 339 via network 337.

Once an identification of an object is determined based on recognition of defining features, such identification is utilized, for example, to determine a location of the object within the space. For example, mobile device 335, upon entering the space, may download or otherwise acquire a map or other data that includes identifications for each or some number of objects within the space as well as location information corresponding to those objects. In this example, mobile device 335 refers to such map or other data to retrieve location information for the object based on the identification corresponding to the defining features of the object recognized from the processing of the image.

In an alternate example, the mobile device 335 has a database of object fingerprints and corresponding IDs; and the mobile device 335 transfers the determined identifications to server 339 via network 337. In this alternate example, server 339 includes a database or other collection of data that incorporates identifications for each or some number of objects within the space as well as location-related information for corresponding objects. Server 339, based on the transferred identifications, retrieves location-related information for each object identified by processing of the image captured by the mobile device and transfers such location information back to mobile device 335 via network 337. The location-related information, for example, may specify the location of the respective object or the location within the space relevant to the respective object.

Once mobile device 335 obtains location information for one or more objects, mobile device 335 may then estimate a current location of mobile device 335, at least in relation to the one or more objects. Such estimated location of mobile device 335 may then be utilized, for example, to inform a user of mobile device 335 of the estimated location (e.g., indication of estimated current location depicted on map displayed to user) or to retrieve or otherwise prompt information related to the estimated location to be shared with the user (e.g., directions based on estimated current location or information related to estimated current location).

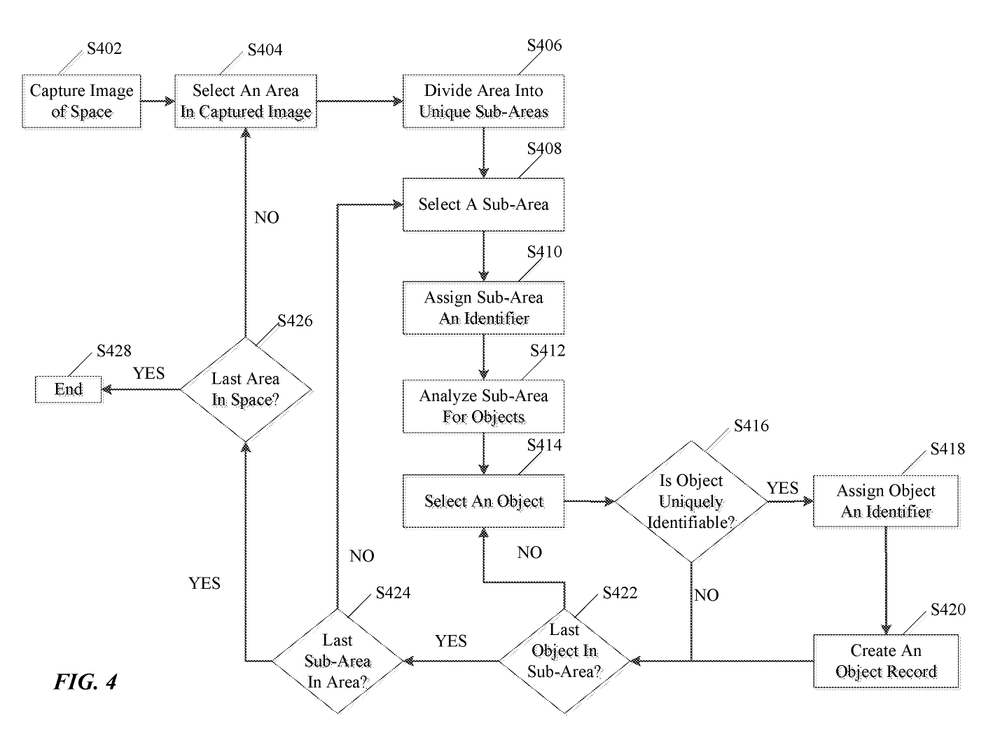

Given a space including various objects, such as depicted by ceiling 101 and/or wall 201 in FIGS. 1-2, an initial implementation or commissioning of the system involves a determination of which objects within the space are uniquely identifiable. As each uniquely identifiable object within the space is determined, a corresponding object record is created. Each object record includes, for example, information describing or otherwise related to the defining features that form a corresponding object fingerprint, information regarding a location of the corresponding object and an identifier of the corresponding object. A flow chart of an example of a process to perform such object identification is depicted in FIG. 4. The process of FIG. 4 may be performed prior to or in conjunction with the space being made available. Thus, FIG. 4, in one sense, depicts an example of a commissioning process for the space.

However, over time, an object fingerprint of a particular object may evolve or change. That is, one or more additional defining features of the object may become exposed (e.g., additional damage or other changes to the object). As such, the process of FIG. 4 may be subsequently performed one or more times. Furthermore, while the process of FIG. 4 will likely be performed by a builder, remodeler or other party responsible for configuring the space to support passive position estimation and/or the owner or occupant of the space, such process, particularly subsequent performances, may be performed at least in part by one or more individuals otherwise unrelated to the space while in the space (e.g., using crowdsourced image capture and/or image processing).

It should be noted that, given constraints and/or limitations of different image sensors, a single image captured by an image sensor may only include a portion of the space (e.g., only ceiling 101, only wall 201, only a portion of ceiling 101 and only a portion of wall 201, etc.). As such, the process of FIG. 4 may be repeatedly performed until the entire space is mapped. However, as image sensors evolve to include the ability to capture panoramic images and/or “stitch” multiple captured images into a single image, the process of FIG. 4 may take advantage of such enhancements and enable mapping an entire space within a single iteration.

In step S402, the process begins by capturing an image of a space. For example, a mobile device operates an image sensor to capture an image that includes one or more objects in the space within the field of view of the sensor. The process may be commenced based on user input, such as a user launching an application on the mobile device; or the mobile device may start the process automatically without any user input, e.g. upon entry to a particular indoor space. Once an image is captured, the captured image is processed in step S404 to select an area of the captured image. As described above, such image processing, for example, occurs on or is otherwise performed by the mobile device. Alternatively, or in addition, such image processing may be performed by a server or other remote computer system.

The selected area, in step S406, is divided into unique sub-areas. For example, if the selected area includes some portion or all of one wall and some portion or all of a ceiling, the wall portion may be one unique sub-area while the ceiling portion may be another unique sub-area. One unique sub-area (e.g., the portion or all of one wall) is selected in step S408 and the selected sub-area is assigned an identifier in step S410.

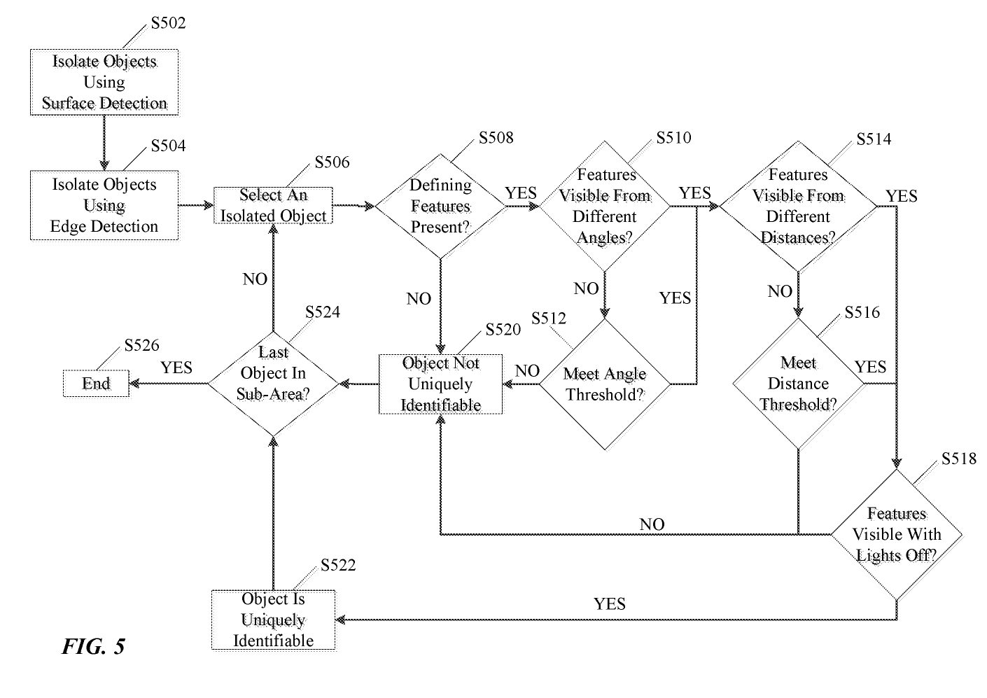

The selected unique sub-area, in step S412, is analyzed for detectable objects. As described in greater detail below in relation to FIG. 5, such analysis may include surface detection and/or edge detection. Once the unique sub-area is analyzed for objects, an individual object is selected in step S414. Step S416 then determines whether the selected object is uniquely identifiable. If the selected object is not uniquely identifiable, the process moves to step S422. Otherwise, if the selected object is uniquely identifiable, the process continues to step S418.

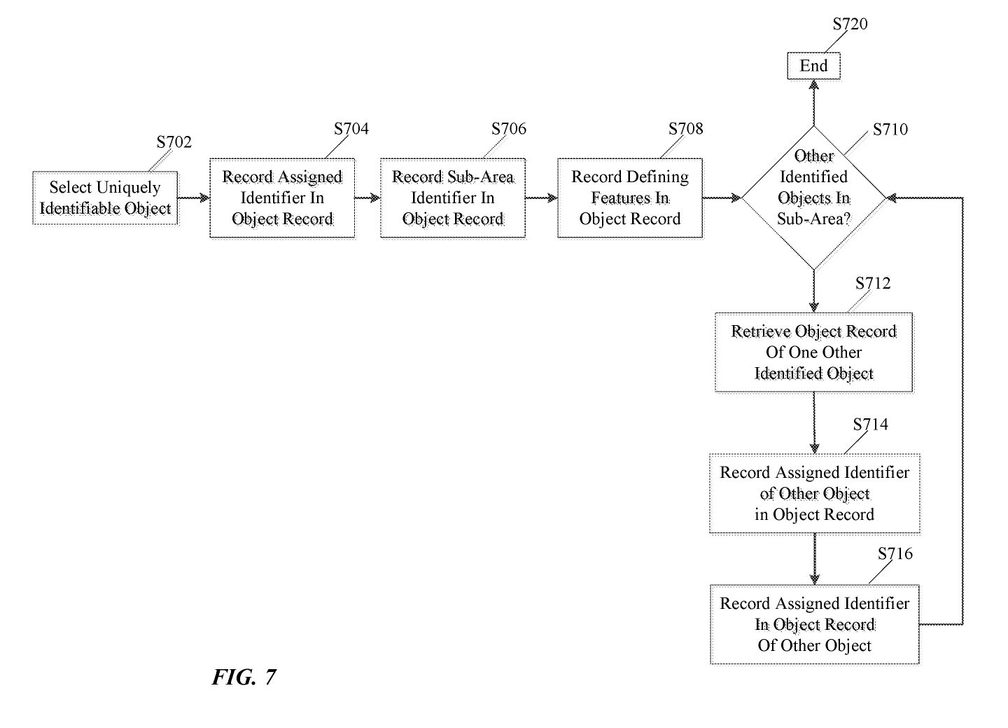

In step S418, the uniquely identifiable object is assigned an object identifier. Then, in step S420, an object record is created. As discussed above, such object record includes, for example, information describing or otherwise related to defining features of the uniquely identifiable object, the assigned object identifier and information regarding a location of the uniquely identifiable object. Such location information includes, for example, positional information of the object (e.g., latitude/longitude, x/y coordinate, etc.) or relational information (e.g., on or otherwise included in another object, positioned next to/above/below another object, etc.). Such location information may be obtained from a data store, provided by a user of the mobile device or otherwise determined by the mobile device. In one example, the object record also includes information about the unique sub-area. As discussed further below in relation to FIG. 7, the object record may also include information about other uniquely identifiable objects, particularly uniquely identifiable objects within the same unique sub-area.

If the selected object is determined to not be the last object in the unique sub-area, step S422 returns to step S414 and another object from the unique sub-area is selected. Otherwise, if the selected object is determined to be the last object in the unique sub-area, step S422 proceeds to step S424. Step S424 determines whether the selected unique sub-area is the last sub-area within the selected area. If not, the process returns to step S408 and another unique sub-area is selected. Otherwise, the process continues to step S426. Step S426 determines whether the selected area is the last area within the captured image. If not, the process returns to step S404 and another area is selected. Otherwise, the process ends in step S428.

While each object in a group of objects includes defining features that create a corresponding fingerprint for the respective object, such object fingerprints may not be known until after each object is manufactured or actually installed within a space. FIG. 5 depicts a flow chart of an example of a process that facilitates isolating objects within a space as well as determining an object fingerprint for an object and thus determining the object as uniquely identifiable. As such, the process of FIG. 5 may be performed as part of steps S412-S416 of the process of FIG. 4.

In step S502, surface detection is used to isolate objects within a selected portion of the image; and, in step S504, edge detection is used to isolate objects within the selected portion of the image. Although FIG. 5 depicts isolating objects using surface detection and edge detection sequentially, this is only for simplicity. Alternatively, edge detection may be used before surface detection or both forms of detection may be used simultaneously in a single step. Furthermore, only one form of detection (e.g., surface detection or edge detection) may be used or use of the second form may be conditioned on the results of the first form (e.g., if surface detection isolates a sufficient number of objects, then edge detection will not be used).

Once some number of objects are isolated, an isolated object is selected in step S506; and, in step S508, the process determines whether defining features for that object are present. If defining features are not present in the object contained within the isolated portion of the image, the process continues to step S520, where the object is determined to not be uniquely identifiable. From step S520, the process continues to step S524. Step S524 determines whether the selected object is the last object within the sub-area. If not, the process returns to step S506 and another isolated object is selected. Otherwise, the process ends in step S526.

If step S508 determines defining features are present, the process continues to step S510. Step S510 determines whether defining features are visible from different angles. If not, the process proceeds to step S512 and determines whether defining features are visible from an angle that meets an angle threshold. If not, the process proceeds to step S520 where the object is determined to not be uniquely identifiable.

If step S510 determines that defining features are visible from different angles or step S512 determines that defining features are visible from an angle that meets an angle threshold, then the process proceeds to step S514. Step S514 determines whether defining features are visible from different distances. If not, the process proceeds to step S516 and determines whether defining features are visible from a distance that meets a distance threshold. If not, the process proceeds to step S520 where the object is determined to not be uniquely identifiable.

If step S514 determines that defining features are visible from different distances or step S516 determines that defining features are visible from a distance that meets a distance threshold, then the process proceeds to step S518. Step S518 determines whether defining features are visible when lights illuminating the space are turned off. That is, step S518 determines whether defining features can be seen regardless of how illumination within the space is functioning. If not, the process proceeds to step S520 where the object is determined to not be uniquely identifiable.

Once defining features are identified and determined to sufficiently uniquely identify the object, the object is determined to be uniquely identifiable in step S522. That is, if the selected object includes a collection of defining features (i.e., object fingerprint) that allows the object to be distinguished from other objects within the space, the object is uniquely identifiable. The process then proceeds to step S524 and a determination is made whether the selected object is the last object in the sub-area. If not, the process returns to step S506. Otherwise, the process ends in step S526.

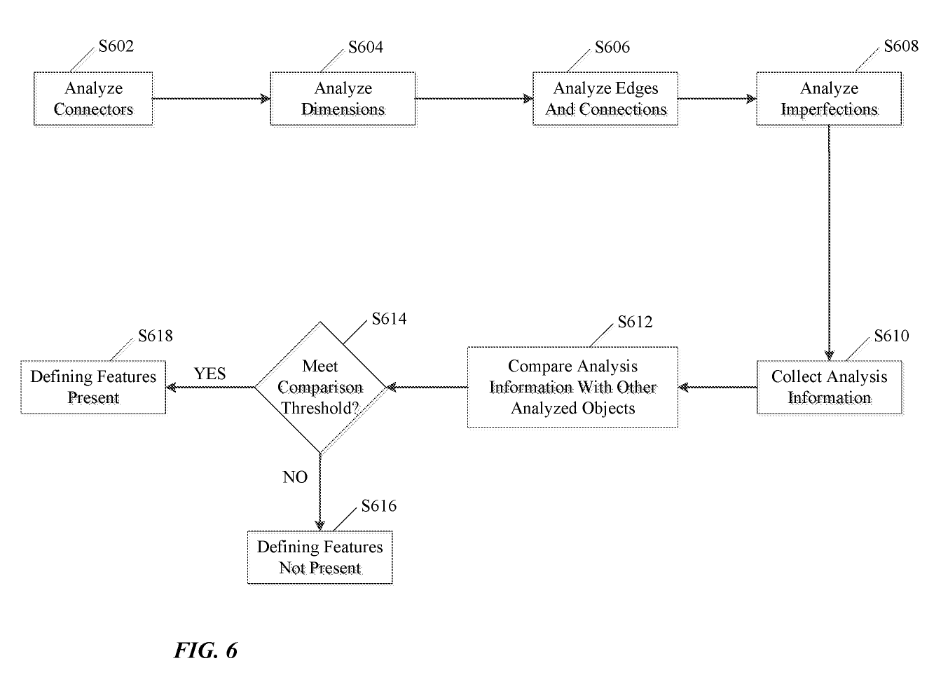

As discussed above, each object may include defining features that collectively form an object fingerprint of the object. However, as also discussed above, each object may include different defining features. Therefore, FIG. 6 illustrates a flow chart of an example of a process that may be utilized to determine whether defining features are present within an object. Such process may be used as part of step S508 of the process of FIG. 5.

The first four steps relate to analyzing elements of an object to identify features that are potentially defining features. Specifically, step S602 analyzes connectors (e.g., how an object is connected or otherwise affixed to another object or portion of the space), step S604 analyzes dimensions (e.g., shape and size of the object), step S606 analyzes edges and connections (e.g., how elements within the object interconnect), and step S608 analyzes imperfections of the object. Although these steps are depicted sequentially in a particular order, that is only for simplicity and these steps may be performed in any order and/or simultaneously. Furthermore, while the process of FIG. 6 depicts four steps analyzing four elements, this is also only for simplicity and any number of steps analyzing any number of elements may be performed.

In step S610, analysis information is collected. In step S612, collected analysis information is compared to analysis information from other analyzed objects. That is, step S612 compares potentially defining features of the object with defining features of other objects. Step S614 determines whether the comparison meets a comparison threshold. In other words, step S614 determines whether the analysis information identifying potentially defining features of the object sufficiently distinguishes from defining features of other objects. If not, step S616 indicates that defining features are not present. In this case, the object cannot be uniquely identified based on defining features. Otherwise, step S618 indicates that defining features are present and the object can be uniquely identified based on defining features.

As mentioned above in relation to a created object record, it may be helpful to associate a uniquely identifiable object within a sub-area with other uniquely identifiable objects within the same sub-area. FIG. 7 depicts a flow chart of an example of a process for associating a uniquely identifiable object with other uniquely identifiable objects within the same sub-area.

In step S702, a uniquely identifiable object is selected. In one example, object selection occurs when an object is determined to be uniquely identifiable during the process of FIG. 4. That is, the process of FIG. 7 may occur as part of steps S418-S420. In this example, then, the selected object is the uniquely identifiable object for which an object record is to be created in step S420.

In step S704, the assigned object identifier is recorded as part of the object record. In step S706, the sub-area identifier of the sub-area in which the object exists is recorded as part of the object record. Defining features of the object (i.e., the object fingerprint), in step S708, are recorded in the object record. Thus, steps S704-S708 represent one approach to creating an object record or part of an object record. Although FIG. 7 depicts these steps in a particular order, this is only for simplicity and steps S704-S708 may be performed in any order.

Whether the sub-area includes other identified objects is determined in step S710. If no other identified objects exist or all of the identified objects have already been associated, then the process ends in step S720. Otherwise, the process continues to step S712 where an object record for another identified object in the sub-area is retrieved. The assigned object identifier of the other identified object is determined from the retrieved object record and, in step S714, the assigned object identifier of the other identified object is recorded in the object record of the selected object. Then, in step S716, the assigned identifier of the selected object is recorded in the object record of the other identified object. The process then returns to step S710 where a determination of whether further identified objects need to be associated. In this way, the process of FIG. 7 allows a newly identified object to be associated with any previously identified objects within the same sub-area.

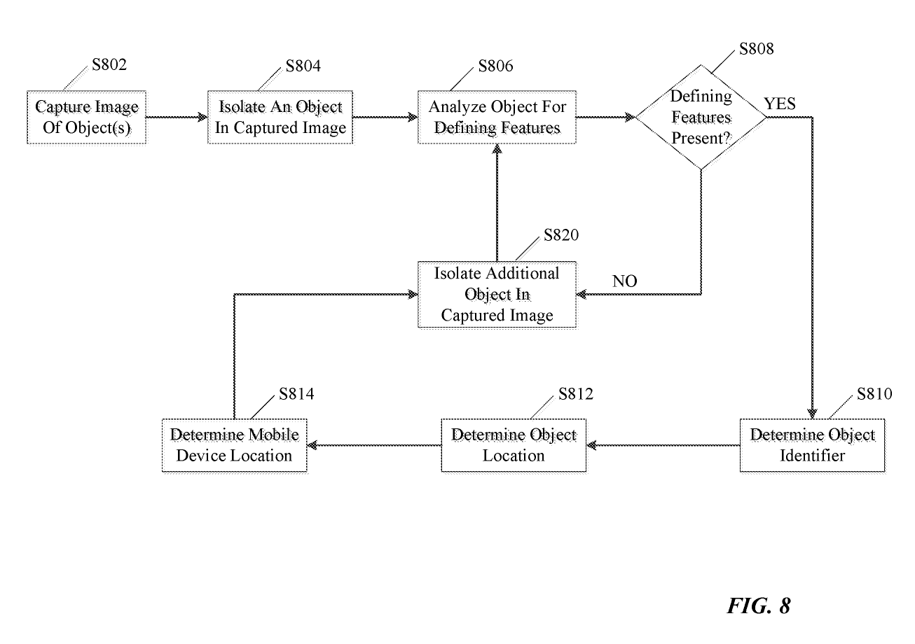

As can be seen from the above discussion related to FIGS. 3-6, various defining features may be utilized to uniquely identify an individual object and create an object record. Given a predetermined location of one or more uniquely identifiable objects, a location of a mobile device may be estimated, at least in relation to the one or more uniquely identifiable objects. FIG. 8 illustrates a flow chart of an example of a process for utilizing a uniquely identifiable object to facilitate location estimation for a mobile device.

In step S802, the process begins by capturing an image of one or more objects. For example, a mobile device operates an image sensor to capture an image that includes one or more objects within the field of view of the sensor. The process may be commenced based on user input, such as a user launching an application on the mobile device; or the mobile device may start the process automatically without any user input, e.g. upon entry to a particular indoor space. Once an image is captured, the captured image is processed in step S804 to isolate a portion of the image containing an object from within the captured image. As described above, such image processing, for example, occurs on or is otherwise performed by the mobile device. Alternatively, or in addition, such image processing may be performed by a server or other remote computer system.

Once a portion of the image containing an object is isolated, the object is analyzed for the presence of defining features in step S806 and, in step S808, the process determines whether defining features are present. If defining features are not present in the object contained within the isolated portion of the image, the process continues to step S820, where an additional portion of the image containing an additional object is isolated in the captured image. The process then returns to step S806 where the additional isolated portion of the image containing the additional object is analyzed for defining features.

If step S808 determines defining features are present, the process continues to step S810. In step S810, an identifier of the object is determined. For example, an identifier corresponding to the defining features is retrieved or otherwise obtained. The defining features, for example, are included as keys or terms within a search query and a previously created object record corresponding to the defining features is selected, for example, from a table of object records stored in a database or data store. The corresponding identifier is then obtained from the retrieved object record. In this way, the object is uniquely identified as among a set of objects within a space.

A location of the identified object is determined in step S812. In one example, the unique identity of the identified object is transmitted to a server or remote computer system via network communications. The server, upon receipt of the unique identity, may look for a record containing a matching unique identity within a database or other data store. The record containing the matching unique identity also contains, for example, data indicating or identifying a location of the identified object. For example, the record may contain information specifying the known position for the identified object relative to the space within which the object is installed. Alternatively, such positional information may be related to a global position, such as latitude and longitude. Once the positional information is retrieved by the server, the server transmits the positional information back to the mobile device.

In an alternate example, such positional information is stored locally within the mobile device in conjunction with the unique identity. For example, upon entering a space, the mobile device downloads or otherwise acquires unique identities and corresponding positional information for all or some number of objects within the space. In this alternate example, the mobile device reviews the locally stored information to determine the location of the object.

Once the location of the object is determined in step S812, step S814 utilizes the object location to estimate a location of the mobile device. For example, a location relative to the object is estimated based on the object location. In some situations, the mobile device location may not be estimated based on identification of a single object. Instead, at least two uniquely identifiable objects together are required to estimate the mobile device location. For example, if the mobile device is not directly underneath or relatively near the identified object, an estimation of the mobile device location may not be sufficiently accurate. In these situations, the process may return to step S820 where an additional object is isolated in the captured image and continue as previously described. Then, the at least two uniquely identifiable objects are utilized to estimate the mobile device location. Otherwise, the process ends in step S814.

Although not explicitly depicted in FIG. 8, the process may be repeated as necessary. For example, as a user moves through a space, the process of FIG. 8 is performed after a predetermined time period (e.g., every 5 seconds, every 2 minutes, every ¼ of a second, etc.). In this way, the location of the mobile device is updated as the mobile device is moved around within the space.

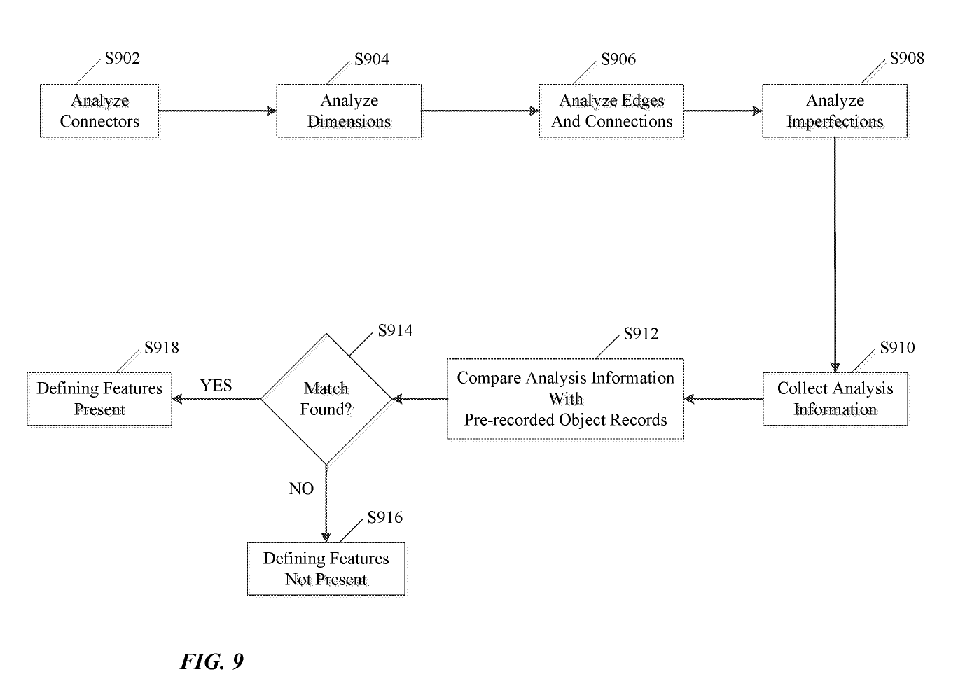

FIG. 9 illustrates a flow chart of an example of a process used to analyze a portion of an image representing an isolated object to determine whether defining features are present. Such a process may be used as part of steps S806 and S808 of the process of FIG. 8. While the process of FIG. 9 is similar to the process of FIG. 6, the two processes differ in that the process of FIG. 6 is identifying whether an object can be uniquely identified based on defining features and the process of FIG. 9 is attempting to use defining features of an object to find a corresponding object record.

The first four steps relate to analyzing elements of an object to identify features that are potentially defining features. Specifically, step S902 analyzes connectors (e.g., how an object is connected or otherwise affixed to another object or portion of the space), step S904 analyzes dimensions (e.g., shape and size of the object), step S906 analyzes edges and connections (e.g., how elements within the object interconnect), and step S908 analyzes imperfections of the object. Although these steps are depicted sequentially in a particular order, that is only for simplicity and these steps may be performed in any order and/or simultaneously. Furthermore, while the process of FIG. 9 depicts four steps analyzing four elements, this is also only for simplicity and any number of steps analyzing any number of elements may be performed.

In step S910, analysis information is collected. In step S912, collected analysis information is compared to analysis information from object records. That is, step S912 compares potentially defining features of the object with defining features previously recorded as part of object records in a database or other data store. Step S914 determines whether a match is found. In other words, step S914 determines whether the analyzed object was previously identified and a corresponding object record created. That is, if the analyzed object is uniquely identifiable, then an object record including the defining features would have previously been created. If not, step S916 indicates that defining features are not present. In this case, the object cannot be uniquely identified based on defining features. Otherwise, step S918 indicates that defining features are present and a corresponding object record exists. Thus the analyzed object is uniquely identifiable.

As can be seen from the above discussion, location estimation of a mobile device can be facilitated by utilization of a “fingerprint” based on a set of defining features of a uniquely identifiable object. Although not shown, such passive identification of objects may be enhanced by the addition of one or more forms of active identification, such as VLC-based identification of a light fixture. For example, passive identification as described herein is utilized to identify a first object and active identification may be utilized to identify a second object which is a light fixture. Then, data of known locations of both objects, based on both passive and active identification, may be utilized to estimate a location of the mobile device. Such active identification may include processing of information modulated onto emitted light, such as in visible light communication.

The term “coupled” as used herein refers to any logical, physical or electrical connection, link or the like by which signals produced by one system element are imparted to another “coupled” element. Unless described otherwise, coupled elements or devices are not necessarily directly connected to one another and may be separated by intermediate components, elements or communication media that may modify, manipulate or carry the signals.

As shown by the above discussion, functions relating to the process of identifying a uniquely identifiable object from a unique fingerprint of defining features of the object as well as methods to identify a number of such objects to facilitate mobile device location estimation may be implemented at least in part on a portable handheld device. At a high level, such a device includes components such as a camera, a processor coupled to the camera to control camera operation and to receive image data from the camera, a memory coupled to be accessible to the processor, and programming in the memory for execution by the processor. The portable handheld device may be any of a variety of modern devices, such as a handheld digital music player, a portable video game or handheld video game controller, etc. In most examples discussed herein, the portable handheld device is a mobile device, such as a smartphone, a wearable smart device (e.g. watch or glasses), a tablet computer or the like. Those skilled in such hi-tech portable handheld devices will likely be familiar with the overall structure, programming and operation of the various types of such devices. For completeness, however, it may be helpful to summarize relevant aspects of a mobile device as just one example of a suitable portable handheld device. For that purpose, FIG. 10 provides a functional block diagram illustration of a mobile device 1000, which may serve as the device 335 in the system of FIG. 3.

In the example, the mobile device 1000 includes one or more processors 1001, such as a microprocessor or the like serving as the central processing unit (CPU) or host processor of the device 1000. Other examples of processors that may be included in such a device include math co-processors, image processors, application processors (APs) and one or more baseband processors (BPs). The various included processors may be implemented as separate circuit components or can be integrated in one or more integrated circuits, e.g. on one or more chips. For ease of further discussion, we will refer to a single processor 1001, although as outlined, such a processor or processor system of the device 1000 may include circuitry of multiple processing devices.

In the example, the mobile device 1000 also includes memory interface 1003 and peripherals interface 1005, connected to the processor 1001 for internal access and/or data exchange within the device 1000. These interfaces 1003, 1005 also are interconnected to each other for internal access and/or data exchange within the device 1000. Interconnections can use any convenient data communication technology, e.g. signal lines or one or more data and/or control buses (not separately shown) of suitable types.

In the example, the memory interface 1003 provides the processor 1001 and peripherals coupled to the peripherals interface 1005 storage and/or retrieval access to memory 1007. Although shown as a single hardware circuit for convenience, the memory 1007 may include one, two or more types of memory devices, such as high-speed random access memory (RAM) and/or non-volatile memory, such as read only memory (ROM), flash memory, micro magnetic disk storage devices, etc. As discussed more later, memory 1007 stores programming 1009 for execution by the processor 1001 as well as data to be saved and/or data to be processed by the processor 1001 during execution of instructions included in the programming 1009. New programming can be saved to the memory 1007 by the processor 1001. Data can be retrieved from the memory 1007 by the processor 1001; and data can be saved to the memory 1007 and in some cases retrieved from the memory 1007, by peripherals coupled via the interface 1005.

In the illustrated example of a mobile device architecture, sensors, various input output devices, and the like are coupled to and therefore controllable by the processor 1001 via the peripherals interface 1005. Individual peripheral devices may connect directly to the interface or connect via an appropriate type of subsystem.

The mobile device 1000 also includes appropriate input/output devices and interface elements. The example offers visual and audible inputs and outputs, as well as other types of inputs.

Although a display together with a keyboard/keypad and/or mouse/touchpad or the like may be used, the illustrated mobile device example 1000 uses a touchscreen 1011 to provide a combined display output to the device user and a tactile user input. The display may be a flat panel display, such as a liquid crystal display (LCD). For touch sensing, the user inputs would include a touch/position sensor, for example, in the form of transparent capacitive electrodes in or overlaid on an appropriate layer of the display panel. At a high level, a touchscreen displays information to a user and can detect occurrence and location of a touch on the area of the display. The touch may be an actual touch of the display device with a finger, stylus or other object; although at least some touchscreens can also sense when the object is in close proximity to the screen. Use of a touchscreen 1011 as part of the user interface of the mobile device 1000 enables a user of that device 1000 to interact directly with the information presented on the display.

A touchscreen input/output (I/O) controller 1013 is coupled between the peripherals interface 1005 and the touchscreen 1011. The touchscreen I/O controller 1013 processes data received via the peripherals interface 1005 and produces drive similar for the display component of the touchscreen 1011 to cause that display to output visual information, such as images, animations and/or video. The touchscreen I/O controller 1013 also includes the circuitry to drive the touch sensing elements of the touchscreen 1011 and processing the touch sensing signals from those elements of the touchscreen 1011. For example, the circuitry of touchscreen I/O controller 1013 may apply appropriate voltage across capacitive sensing electrodes and process sensing signals from those electrodes to detect occurrence and position of each touch of the touchscreen 1011. The touchscreen I/O controller 1013 provides touch position information to the processor 1001 via the peripherals interface 1005, and the processor 1001 can correlate that information to the information currently displayed via the display 1011, to determine the nature of user input via the touchscreen.

As noted, the mobile device 1000 in our example also offer audio inputs and/or outputs. The audio elements of the device 1000 support audible communication functions for the user as well as providing additional user input/output functions. Hence, in the illustrated example, the mobile device 1000 also includes a microphone 1015, configured to detect audio input activity, as well as an audio output component such as one or more speakers 1017 configured to provide audible information output to the user. Although other interfaces subsystems may be used, the example utilizes an audio coder/decoder (CODEC), as shown at 1019, to interface audio to/from the digital media of the peripherals interface 1005. The CODEC 1019 converts an audio responsive analog signal from the microphone 1015 to a digital format and supplies the digital audio to other element(s) of the device 1000, via the peripherals interface 1005. The CODEC 1019 also receives digitized audio via the peripherals interface 1005 and converts the digitized audio to an analog signal which the CODEC 1019 outputs to drive the speaker 1017. Although not shown, one or more amplifiers may be included in the audio system with the CODEC to amplify the analog signal from the microphone 1015 or the analog signal from the CODEC 1019 that drives the speaker 1017.

Other user input/output (I/O) devices 1021 can be coupled to the peripherals interface 1005 directly or via an appropriate additional subsystem (not shown). Such other user input/output (I/O) devices 1021 may include one or more buttons, rocker switches, thumb-wheel, infrared port, etc. as additional input elements. Examples of one or more buttons that may be present in a mobile device 1000 include a home or escape button, an ON/OFF button, and an up/down button for volume control of the microphone 1015 and/or speaker 1017. Examples of output elements include various light emitters or tactile feedback emitters (e.g. vibrational devices). If provided, functionality of any one or more of the buttons, light emitters or tactile feedback generators may be context sensitive and/or customizable by the user.

The mobile device 1000 in the example also includes one or more Micro ElectroMagnetic System (MEMS) sensors shown collectively at 1023. Such MEMS devices 1023, for example, can perform compass and orientation detection functions and/or provide motion detection. In this example, the elements of the MEMS 1023 coupled to the peripherals interface 1005 directly or via an appropriate additional subsystem (not shown) include a gyroscope (GYRO) 1025 and a magnetometer 1027. The elements of the MEMS 1023 may also include a motion detector 1029 and/or an accelerometer 1031, e.g. instead of or as a supplement to detection functions of the GYRO 1025.

The mobile device 1000 in the example also includes a global positioning system (GPS) receiver 1033 coupled to the peripherals interface 1005 directly or via an appropriate additional subsystem (not shown). In general, a GPS receiver 1033 receives and processes signals from GPS satellites to obtain data about the positions of satellites in the GPS constellation as well as timing measurements for signals received from several (e.g. 3-5) of the satellites, which a processor (e.g. the host processor 1001 or another internal or remote processor in communication therewith) can process to determine the geographic location of the device 1000.

In the example, the mobile device 1000 further includes one or more cameras 1035 as well as camera subsystem 1037 coupled to the peripherals interface 1005. A smartphone or tablet type mobile station often includes a front facing camera and a rear or back facing camera. Some recent designs of mobile stations, however, have featured additional cameras. Although the camera 1035 may use other image sensing technologies, current examples often use charged coupled device (CCD) or a complementary metal-oxide semiconductor (CMOS) optical sensor. At least some such cameras implement a rolling shutter image capture technique. The camera subsystem 1037 controls the camera operations in response to instructions from the processor 1001; and the camera subsystem 1037 may provide digital signal formatting of images captured by the camera 1035 for communication via the peripherals interface 1005 to the processor or other elements of the device 1000.

The processor 1001 controls each camera 1035 via the peripherals interface 1005 and the camera subsystem 1037 to perform various image or video capture functions, for example, to take pictures or video clips in response to user inputs. The processor 1001 may also control a camera 1035 via the peripherals interface 1005 and the camera subsystem 1037 to obtain data detectable in a captured image, such as data represented by a code passively depicted as defining features recognizable in an image or actively modulated in visible light communication (VLC) detectable in an image. In the data capture case, the camera 1035 and the camera subsystem 1037 supply image data via the peripherals interface 1005 to the processor 1001, and the processor 1001 processes the image data to extract or demodulate data from the captured image(s).

Voice and/or data communication functions are supported by one or more wireless communication transceivers 1039. In the example, the mobile device includes a cellular or other mobile transceiver 1041 for longer range communications via a public mobile wireless communication network. A typical modern device, for example, might include a 4G LTE (long term evolution) type transceiver. Although not shown for convenience, the mobile device 1000 may include additional digital or analog transceivers for alternative wireless communications via a wide area wireless mobile communication network.

Many modern mobile devices also support wireless local communications over one or more standardized wireless protocols. Hence, in the example, the wireless communication transceivers 1039 also include at least one shorter range wireless transceiver 1043. Typical examples of the wireless transceiver 1043 include various iterations of WiFi (IEEE 802.11) transceivers and Bluetooth (IEEE 802.15) transceivers, although other or additional types of shorter range transmitters and/or receivers may be included for local communication functions.

As noted earlier, the memory 1007 stores programming 1009 for execution by the processor 1001 as well as data to be saved and/or data to be processed by the processor 1001 during execution of instructions included in the programming 1009. For example, the programming 1009 may include an operating system (OS) and programming for typical functions such as communications (COMM.), image processing (IMAGE PROC'G) and positioning (POSIT'G). Examples of typical operating systems include iOS, Android, BlackBerry OS and Windows for Mobile. The OS also allows the processor 1001 to execute various higher layer applications (APPs) that use the native operation functions such as communications, image processing and positioning.

In several of the above examples, mobile device 1000 may control camera 1035 and camera subsystem 1037 to capture an image and process, by processor 1001 and based on instructions stored in memory 1007 as part of programming 1009, the captured image to identify a uniquely identifiable object included within the captured image. As described in greater detail above, mobile device 1000 may determine, based on the unique identifications, a location of the uniquely identifiable object. For example, mobile device 1000 may utilize the wireless transceivers 1039 to transmit the unique identifications to a server and receive a corresponding location from the server. In turn, mobile device 1000 may determine, based on the location of the object, a relative location of mobile device 1000. Once the relative location of the mobile device 1000 is determined, mobile device 1000, via touchscreen I/O controller 1013, may depict an indication of that location on touchscreen 1011 and/or present information about that location. Other location-related information, e.g. turn by run directions to a desired destination, may be presented via the touchscreen 1011. In this way, a location for mobile device 1000 may be determined and presented to a user of device 1000.

As shown by the above discussion, functions relating to the process of identifying a uniquely identifiable object from a unique fingerprint of defining features of the object to facilitate mobile device location estimation may be implemented on computers connected for data communication via the components of a packet data network, operating as a server as shown in FIG. 3. Although special purpose devices may be used, such devices also may be implemented using one or more hardware platforms intended to represent a general class of user's data processing device commonly used to run “client” programming and/or a general class of data processing device commonly used to run “server” programming. The user device may correspond to mobile device 335 of FIG. 3 whereas the server computer may be configured to implement various location determination related functions as discussed above.

As known in the data processing and communications arts, a general-purpose computing device, computer or computer system typically comprises a central processor or other processing device, internal data connection(s), various types of memory or storage media (RAM, ROM, EEPROM, cache memory, disk drives etc.) for code and data storage, and one or more network interfaces for communication purposes. The software functionalities involve programming, including executable code as well as associated stored data, e.g. files used for the mobile device location determination service/function(s). The software code is executable by the general-purpose computer that functions as the server and/or that functions as a user terminal device. In operation, the code is stored within the general-purpose computer platform. At other times, however, the software may be stored at other locations and/or transported for loading into the appropriate general-purpose computer system. Execution of such code by a processor of the computer platform enables the platform to implement the methodology for utilizing a uniquely identifiable light fixture to facilitate mobile device location determination, in essentially the manner performed in the implementations discussed and illustrated herein. Although those skilled in the art likely are familiar with the structure, programming and general operation of such computer systems, it may be helpful to consider some high-level examples.

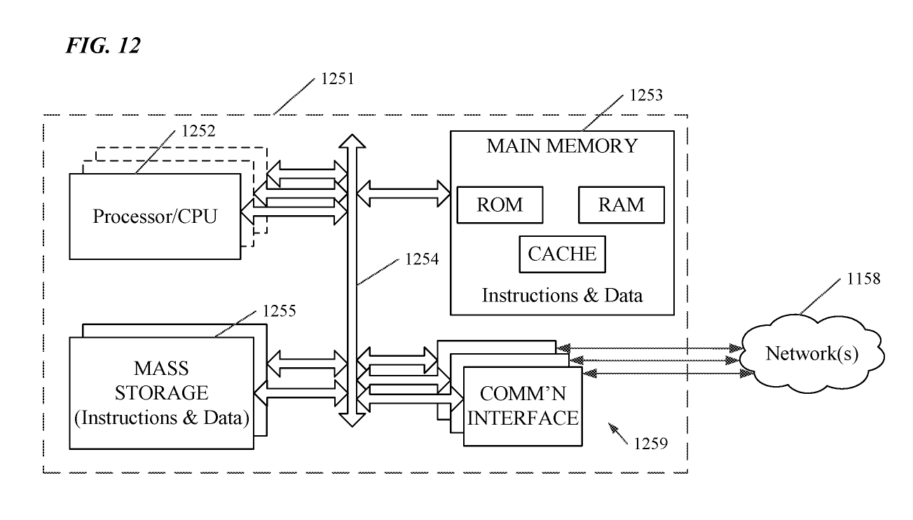

FIGS. 11 and 12 provide functional block diagram illustrations of general purpose computer hardware platforms. FIG. 11 depicts a computer with user interface elements, as may be used to implement a client computer or other type of work station or terminal device, although the computer of FIG. 11 may also act as a host or server if appropriately programmed. FIG. 12 illustrates a network or host computer platform, as may typically be used to implement a server.

With reference to FIG. 11, a user device type computer system 1151, which may serve as a user terminal, includes processor circuitry forming a central processing unit (CPU) 1152. The circuitry implementing the CPU 1152 may be based on any processor or microprocessor architecture such as a Reduced Instruction Set Computing (RISC) using an ARM architecture, as commonly used today in mobile devices and other portable electronic devices, or a microprocessor architecture more commonly used in computers such as an Instruction Set Architecture (ISA) or Complex Instruction Set Computing (CISC) architecture. The CPU 1152 may use any other suitable architecture. Any such architecture may use one or more processing cores. The CPU 1152 may contain a single processor/microprocessor, or it may contain a number of microprocessors for configuring the computer system 1151 as a multi-processor system.

The computer system 1151 also includes a main memory 1153 that stores at least portions of instructions for execution by and data for processing by the CPU 1152. The main memory 1153 may include one or more of several different types of storage devices, such as read only memory (ROM), random access memory (RAM), cache and possibly an image memory (e.g. to enhance image/video processing). Although not separately shown, the memory 1153 may include or be formed of other types of known memory/storage devices, such as PROM (programmable read only memory), EPROM (erasable programmable read only memory), FLASH-EPROM, or the like.

The system 1151 also includes one or more mass storage devices 1154. Although a storage device 1154 could be implemented using any of the known types of disk drive or even tape drive, the trend is to utilize semiconductor memory technologies, particularly for portable or handheld system form factors. As noted, the main memory 1153 stores at least portions of instructions for execution and data for processing by the CPU 1152. The mass storage device 1154 provides longer term non-volatile storage for larger volumes of program instructions and data. For a personal computer, or other similar device example, the mass storage device 1154 may store the operating system and application software as well as content data, e.g. for uploading to main memory and execution or processing by the CPU 1152. Examples of content data include messages and documents, and various multimedia content files (e.g. images, audio, video, text and combinations thereof), Instructions and data can also be moved from the CPU 1152 and/or memory 1153 for storage in device 1154.

The processor/CPU 1152 is coupled to have access to the various instructions and data contained in the main memory 1153 and mass storage device 1154. Although other interconnection arrangements may be used, the example utilizes an interconnect bus 1155. The interconnect bus 1155 also provides internal communications with other elements of the computer system 1151.

The system 1151 also includes one or more input/output interfaces for communications, shown by way of example as several interfaces 1159 for data communications via a network 1158. The network 1158 may be or communicate with the network 337 of FIG. 3. Although narrowband modems are also available, increasingly each communication interface 1159 provides a broadband data communication capability over wired, fiber or wireless link. Examples include wireless (e.g. WiFi) and cable connection Ethernet cards (wired or fiber optic), mobile broadband ‘aircards,’ and Bluetooth access devices. Infrared and visual light type wireless communications are also contemplated. Outside the system 1151, the interfaces provide communications over corresponding types of links to the network 1158. In the example, within the system 1151, the interfaces communicate data to and from other elements of the system via the interconnect bus 1155.

For operation as a user terminal device, the computer system 1151 further includes appropriate input/output devices and interface elements. The example offers visual and audible inputs and outputs, as well as other types of inputs. Although not shown, the system may also support other types of output, e.g. via a printer. The input and output hardware devices are shown as elements of the device or system 1151, for example, as may be the case if the computer system 1151 is implemented as a portable computer device (e.g. laptop, notebook or ultrabook), tablet, smartphone or other handheld device. In other implementations, however, some or all of the input and output hardware devices may be separate devices connected to the other system elements via wired or wireless links and appropriate interface hardware.

For visual output, the computer system 1151 includes an image or video display 1161 and an associated decoder and display driver circuit 1162. The display 1161 may be a projector or the like but typically is a flat panel display, such as a liquid crystal display (LCD). The decoder function decodes video or other image content from a standard format, and the driver supplies signals to drive the display 1161 to output the visual information. The CPU 1152 controls image presentation on the display 1161 via the display driver 1162, to present visible outputs from the device 1151 to a user, such as application displays and displays of various content items (e.g. still images, videos, messages, documents, and the like).

In the example, the computer system 1151 also includes a camera 1163 as a visible light image sensor. Various types of cameras may be used. The camera 1163 typically can provide still images and/or a video stream, in the example to an encoder 1164. The encoder 1164 interfaces the camera to the interconnect bus 1155. For example, the encoder 1164 converts the image/video signal from the camera 1163 to a standard digital format suitable for storage and/or other processing and supplies that digital image/video content to other element(s) of the system 1151, via the bus 1155. Connections to allow the CPU 1152 to control operations of the camera 1163 are omitted for simplicity.

In the example, the computer system 1151 includes a microphone 1165, configured to detect audio input activity, as well as an audio output component such as one or more speakers 1166 configured to provide audible information output to the user. Although other interfaces may be used, the example utilizes an audio coder/decoder (CODEC), as shown at 1167, to interface audio to/from the digital media of the interconnect bus 1155. The CODEC 1167 converts an audio responsive analog signal from the microphone 1165 to a digital format and supplies the digital audio to other element(s) of the system 1151, via the bus 1155. The CODEC 1167 also receives digitized audio via the bus 1155 and converts the digitized audio to an analog signal which the CODEC 1167 outputs to drive the speaker 1166. Although not shown, one or more amplifiers may be included to amplify the analog signal from the microphone 1165 or the analog signal from the CODEC 1167 that drives the speaker 1166.

Depending on the form factor and intended type of usage/applications for the computer system 1151, the system 1151 will include one or more of various types of additional user input elements, shown collectively at 1168. Each such element 1168 will have an associated interface 1169 to provide responsive data to other system elements via bus 1155. Examples of suitable user inputs 1168 include a keyboard or keypad, a cursor control (e.g. a mouse, touchpad, trackball, cursor direction keys etc.).

Another user interface option provides a touchscreen display feature. At a high level, a touchscreen display is a device that displays information to a user and can detect occurrence and location of a touch on the area of the display. The touch may be an actual touch of the display device with a finger, stylus or other object; although at least some touchscreens can also sense when the object is in close proximity to the screen. Use of a touchscreen display as part of the user interface enables a user to interact directly with the information presented on the display. The display may be essentially the same as discussed above relative to element 1161 as shown in the drawing. For touch sensing, however, the user inputs 1168 and interfaces 1169 would include a touch/position sensor and associated sense signal processing circuit. The touch/position sensor is relatively transparent, so that the user may view the information presented on the display 1161. The sense signal processing circuit receives sensing signals from elements of the touch/position sensor and detects occurrence and position of each touch of the screen formed by the display and sensor. The sense circuit provides touch position information to the CPU 1152 via the bus 1155, and the CPU 1152 can correlate that information to the information currently displayed via the display 1161, to determine the nature of user input via the touchscreen.

A mobile device type user terminal may include elements similar to those of a laptop or desktop computer, but will typically use smaller components that also require less power, to facilitate implementation in a portable form factor. Some portable devices include similar but smaller input and output elements. Tablets and smartphones, for example, utilize touch sensitive display screens, instead of separate keyboard and cursor control elements.

Each computer system 1151 runs a variety of applications programs and stores data, enabling one or more interactions via the user interface, provided through elements, and/or over the network 1158 to implement the desired user device processing for the device location determination service based on a uniquely identifiable light fixture described herein or the processing of captured images for such device location determination services. The user computer system/device 1151, for example, runs a general purpose browser application and/or a separate device location determination application program.

Turning now to consider a server or host computer, FIG. 12 is a functional block diagram of a general-purpose computer system 1251, which may perform the functions of the server 337 in FIG. 3 or the like.

The example 1251 will generally be described as an implementation of a server computer, e.g. as might be configured as a blade device in a server farm. Alternatively, the computer system may comprise a mainframe or other type of host computer system capable of web-based communications, media content distribution, or the like via the network 1158. Although shown as the same network as served the user computer system 1151, the computer system 1251 may connect to a different network.

The computer system 1251 in the example includes a central processing unit (CPU) 1252, a main memory 1253, mass storage 1255 and an interconnect bus 1254. These elements may be similar to elements of the computer system 1151 or may use higher capacity hardware. The circuitry forming the CPU 1252 may contain a single microprocessor, or may contain a number of microprocessors for configuring the computer system 1252 as a multi-processor system, or may use a higher speed processing architecture. The main memory 1253 in the example includes ROM, RAM and cache memory; although other memory devices may be added or substituted. Although semiconductor memory may be used in the mass storage devices 1255, magnetic type devices (tape or disk) and optical disk devices typically provide higher volume storage in host computer or server applications. In operation, the main memory 1253 stores at least portions of instructions and data for execution by the CPU 1252, although instructions and data are moved between memory and storage and CPU via the interconnect bus in a manner similar to transfers discussed above relative to the system 1151 of FIG. 11.

The system 1251 also includes one or more input/output interfaces for communications, shown by way of example as interfaces 1259 for data communications via the network 1158. Each interface 1259 may be a high-speed modem, an Ethernet (optical, cable or wireless) card or any other appropriate data communications device. To provide the device location determination service to a large number of users' client devices, the interface(s) 1259 preferably provide(s) a relatively high-speed link to the network 1158. The physical communication link(s) may be optical, wired, or wireless (e.g., via satellite or cellular network).

Although not shown, the system 1251 may further include appropriate input/output ports for interconnection with a local display and a keyboard or the like serving as a local user interface for configuration, programming or trouble-shooting purposes. Alternatively, the server operations personnel may interact with the system 1251 for control and programming of the system from remote terminal devices via the Internet or some other link via network 1158.

The computer system 1251 runs a variety of applications programs and stores the necessary information for support of the device location determination service described herein. One or more such applications enable the delivery of web pages and/or the generation of e-mail messages. Those skilled in the art will recognize that the computer system 1251 may run other programs and/or host other web-based or e-mail based services. As such, the system 1251 need not sit idle while waiting for device location determination service related functions. In some applications, the same equipment may offer other services.

The example (FIG. 12) shows a single instance of a computer system 1251. Of course, the server or host functions may be implemented in a distributed fashion on a number of similar platforms, to distribute the processing load. Additional networked systems (not shown) may be provided to distribute the processing and associated communications, e.g. for load balancing or failover.

The hardware elements, operating systems and programming languages of computer systems like 1151, 1251 generally are conventional in nature, and it is presumed that those skilled in the art are sufficiently familiar therewith to understand implementation of the present device location determination technique using suitable configuration and/or programming of such computer system(s) particularly as outlined above relative to 1151 of FIG. 11 and 1251 of FIG. 12.

Hence, aspects of the methods of identifying a uniquely identifiable object and/or detecting such objects to facilitate mobile device location estimation outlined above may be embodied in programming, e.g. in the form of software, firmware, or microcode executable by a user computer system or mobile device, a server computer or other programmable device. Program aspects of the technology may be thought of as “products” or “articles of manufacture” typically in the form of executable code and/or associated data that is carried on or embodied in a type of machine readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform that will be the server 337 of FIG. 3 and/or the computer platform of the user that will be the client device for the device location determination service. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to one or more of “non-transitory,” “tangible” or “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the process of utilizing a captured image of one or more uniquely identifiable objects to facilitate mobile device location determination, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and light-based data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Program instructions may comprise a software or firmware implementation encoded in any desired language. Programming instructions, when embodied in machine readable medium accessible to a processor of a computer system or device, render computer system or device into a special-purpose machine that is customized to perform the operations specified in the program.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “a” or “an” does not, without further constraints, preclude the existence of additional identical elements in the process, method, article, or apparatus that comprises the element.

Unless otherwise stated, any and all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

What is claimed is:

1. A method, comprising:
obtaining, by a processor, data of one or more captured images, the one or more captured images including a respective image representation of each of a plurality of objects within a space;
isolating each of the respective image representations from among the one or more captured images; and
for each isolated image representation of an object from among the plurality of objects:
determining whether the respective represented object is uniquely identifiable within the space; and
upon determining that the respective represented object is uniquely identifiable within the space:
determining an object identifier of the respective represented object;
obtaining an object location of the respective represented object; and
creating, based on the object identifier of the respective represented object and the object location of the respective represented object, an object record for the respective represented object.

2. The method of claim 1, wherein:
(a) determining whether the respective represented object is uniquely identifiable within the space further comprises:
identifying an object fingerprint of the respective represented object formed by a plurality of features of the respective represented object, the object fingerprint being:
optically detectable by an image sensor and identifiable by a processor; and
humanly imperceptible as uniquely identifying the respective represented object;
determining the object fingerprint of the respective represented object is sufficient to uniquely identify the respective represented object at least among the plurality of objects within the space; and
upon determining sufficiency of the object fingerprint, determining that the respective represented object is uniquely identifiable within the space; and
(b) creating the object record for the respective represented object is further based on the object fingerprint of the respective represented object.

3. The method of claim 2, wherein:
(c) isolating each of the respective image representations from among the one or more captured images comprises:
selecting an area of the space from one of the one or more captured images;
dividing the selected area into unique sub-areas; and
for each of the unique sub-areas:
determining a sub-area identifier for the respective unique sub-area; and
performing surface detection to isolate each of the respective image representations within the unique sub-area; and
(d) creating the object record for the respective represented object comprises:
determining with which unique sub-area the respective represented object is associated; and
creating the object record for the respective represented object further based on the associated unique sub-area.

4. The method of claim 3, wherein creating the object record for the respective represented object is further based on each of the represented objects associated with the associated unique sub-area.

5. The method of claim 2, wherein:
(c) isolating each of the respective image representations from among the one or more captured images comprises:
selecting an area of the space from one of the one or more captured images;
dividing the selected area into unique sub-areas; and
for each of the unique sub-areas:
determining a sub-area identifier for the respective unique sub-area; and
performing edge detection to isolate each of the respective image representations within the unique sub-area; and
(d) creating the object record for the respective represented object comprises:
determining with which unique sub-area the respective represented object is associated; and
creating the object record for the respective represented object further based on the associated unique sub-area.

6. The method of claim 5, wherein creating the object record for the respective represented object is further based on each of the represented objects associated with the associated unique sub-area.

7. The method of claim 2, wherein:
(c) isolating each of the respective image representations from among the one or more captured images comprises:
selecting an area of the space from one of the one or more captured images;
dividing the selected area into unique sub-areas; and
for each of the unique sub-areas:
determining a sub-area identifier for the respective unique sub-area; and
performing surface detection and edge detection to isolate each of the respective image representations within the unique sub-area; and
(d) creating the object record for the respective represented object comprises:
determining with which unique sub-area the respective represented object is associated; and
creating the object record for the respective represented object further based on the associated unique sub-area.

8. The method of claim 7, wherein creating the object record for the respective represented object is further based on each of the represented objects associated with the associated unique sub-area.

9. The method of claim 2, wherein identifying the object fingerprint of the respective represented object comprises:
transmitting, via a network interface, the image representation of the respective represented object; and
receiving, via the network interface, the object fingerprint of the respective represented object.

10. The method of claim 2, wherein obtaining the location of the respective represented object comprises:
transmitting, via a network interface, the object fingerprint of the respective represented object; and
receiving, via the network interface, data specifying the location of the respective represented object.

11. The method of claim 2, wherein determining the object identifier of the respective represented object comprises:
transmitting, via a network interface, the object fingerprint of the respective represented object; and
receiving, via the network interface, the object identifier of the respective represented object.

12. The method of claim 2, wherein creating the object record for the respective represented object comprises transmitting, via a network interface, the object fingerprint of the respective represented object, the location of the respective represented object, and the object identifier of the respective represented object.

13. The method of claim 1, wherein obtaining data of one or more captured images comprises operating an image sensor to capture the one or more images of the space.

14. The method of claim 1, wherein isolating each of the respective image representations from among the one or more captured images comprises processing the obtained data of the one or more captured images to isolate each of the respective image representations.

15. The method of claim 1, wherein isolating each of the respective image representations from among the one or more captured images comprises:
transmitting, via a network interface, the received data of the one or more captured images; and
receiving, via the network interface, each of the isolated image representations.

16. A portable device, comprising:
an image sensor;
a processor coupled to the image sensor, to control image sensor operation and to receive image data from the image sensor;
a memory coupled to be accessible to the processor; and
programming in the memory for execution by the processor to configure the portable handheld device to perform the method of claim 1.

17. A server computer, comprising:
a network interface;
a processor coupled to the network interface;
a memory coupled to be accessible to the processor; and
programming in the memory for execution by the processor to configure the portable handheld device to perform the method of claim 1.

18. A tangible, non-transitory computer readable medium comprising a set of programming instructions, wherein execution of the set of programming instructions by a processor configures the processor to implement functions, including functions to:
obtain data of one or more captured images, the one or more captured images including respective image representations of each of a plurality of objects within a space;
isolate each of the respective image representations from among the one or more captured images; and
for each isolated image representation of an object from among the plurality of objects:
determine whether the respective represented object is uniquely identifiable within the space; and
upon determining that the respective represented object is uniquely identifiable within the space:
determine an object identifier of the respective represented object;
obtain an object location of the respective represented object; and
create, based on the object identifier of the respective represented object and the object location of the respective represented object, an object record for the respective represented object.

19. A method, comprising:
operating an image sensor of a portable handheld device to capture an image, the captured image including image representations of at least two objects from among a plurality of objects within a space occupied by a user of the portable handheld device;
receiving, by a processor of the portable handheld device and from the image sensor, data of the captured image;
obtaining data of the image representations of the at least two objects from the received data of the captured image;
processing the extracted data of the image representations of the at least two objects to identify object fingerprints of the at least two objects, each object fingerprint formed by a plurality of features of the respective object and each object fingerprint being:
sufficient to uniquely identify the respective object at least among the plurality of objects within the space;
optically detectable by the image sensor and identifiable by the processor; and
humanly imperceptible as uniquely identifying the respective object;
determining identifications of the at least two objects based on the object fingerprints of the at least two objects; and
processing the identifications of the at least two objects to estimate position of the portable handheld device in the space, based at least in part on known positions of the at least two objects in the space.

20. The method of claim 19, wherein the step of processing the identifications of the at least two objects further comprises:
transmitting, via a network interface of the portable handheld device, the identifications of the at least two objects; and
receiving, via the network interface, the known positions of the at least two objects in the space.
